(19) United States
(12) Patent Application Publication
(10) Pub. No.: US 2025/0012313 A1
(43) Pub. Date: Jan. 9, 2025

(54) Fastener and Fastener Assembly

(71) Applicant: Illinois Tool Works Inc., Glenview, IL (US)

(72) Inventors: Zhilin LI, Shanghai (CN); Chao YUAN, Shanghai (CN)

(21) Appl. No.: 18/762,020

(22) Filed: Jul. 2, 2024

(30) Foreign Application Priority Data
Jul. 6, 2023 (CN) 202310827222.X
Jul. 6, 2023 (CN) 202321773361.0

(51) Int. Cl. F16B 37/08

(52) U.S. Cl. CPC F16B 37/0842

(57) ABSTRACT

The present disclosure discloses a fastener and a fastener assembly. The fastener is configured for connecting a first component to a second component, and comprises a main body, at least two clamping arms and at least two abutting arms. The main body is annular. The at least two clamping arms are formed by extending from the main body and configured to clamp the first component. The at least two abutting arms are formed by extending from the main body and configured to abut against the second component. The first component and the second component of the fastener assembly of the present application can be connected to each other stably via the fastener.

### RELATED APPLICATIONS

The present application claims the benefit of Chinese Patent Application Nos. 202310827222.X, filed Jul. 6, 2023, and 202321773361.0, filed Jul. 6, 2023, each titled “Fastener and Fastener Assembly,” the contents of which are hereby incorporated by reference.

### BACKGROUND

A fastener is configured for connecting a first component to a second component (e.g., connecting a plastic panel to a post of a vehicle). During connection, the second component is firstly sheathed on the post of the first component, and the fastener is then sleeved on the post of the first component, so that the first component is connected to the second component.

### SUMMARY

The present disclosure generally relates to a fastener and fastener assembly, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1A is a perspective view of a fastener.

FIG. 1B is a vertical cross-sectional view of the fastener shown in FIG. 1A.

FIG. 1C is a bottom view of the fastener shown in FIG. 1A.

FIG. 2A is a perspective view of a first embodiment of a fully assembled fastener assembly of the present disclosure.

FIG. 2B is an exploded view of the fastener assembly shown in FIG. 2A.

FIG. 2C is a cross-sectional view of the fastener assembly shown in FIG. 2A.

FIG. 3A is a perspective view of a second embodiment of the fully assembled fastener assembly of the present disclosure.

FIG. 3B is an exploded view of the fastener assembly shown in FIG. 3A.

FIG. 3C is a cross-sectional view of the fastener assembly shown in FIG. 3A.

### DETAILED DESCRIPTION

Various specific implementations of the present disclosure are described below with reference to the drawings which constitute part of this specification. It should be understood that although the terms indicating directions, such as “front”, “rear”, “upper”, “lower”, “left”, “right” and so on are used in the present disclosure to describe structural parts and elements in various examples of the present disclosure, these terms are used herein only for ease of description and are determined based on the exemplary orientations as shown in the accompanying drawings. Since the arrangements in the embodiments disclosed in the present disclosure may be in various directions, these terms indicating directions are only illustrative and should not be considered as limitations.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The ordinal numbers such as “first” and “second” used in the present disclosure are merely used for distinguishing and identification, and do not have any other meanings. Unless otherwise specified, the ordinal numbers neither indicate a specific order, nor have a specific relevance. For example, the term “first clamping surface” itself does not imply the existence of “second clamping surface”, and the term “second clamping surface” itself also does not imply the existence of “first clamping surface”.

According to a first aspect of the present disclosure, the present disclosure provides a fastener for connecting a first component to a second component, the fastener comprising a main body, at least two clamping arms and at least two abutting arms. The main body is annular. The at least two clamping arms are formed by extending from the main body and configured to clamp the first component. The at least two abutting arms are formed by extending from the main body and configured to abut against the second component.

According to the fastener in the first aspect described above, the at least two clamping arms are configured to clamp the first component in a first direction, and the at least two abutting arms are configured to abut against the second component in a second direction. The first direction is substantially perpendicular to the second direction.

According to the fastener in the first aspect described above, each of the at least two abutting arms is formed by extending inwardly from the main body and toward the second component for a certain distance, and then extending away from the second component.

According to the fastener in the first aspect described above, each of the at least two abutting arms comprises a bent portion, and a bottom surface of the bent portion is lower than a bottom surface of the main body.

According to the fastener in the first aspect described above, each of the at least two abutting arms is arranged between two adjacent clamping arms and located between the at least two clamping arms and the second component.

According to the fastener in the first aspect described above, the at least two clamping arms are arranged at a distance from the at least two abutting arms.

According to the fastener in the first aspect described above, each of the at least two clamping arms has a connecting end and a free end, the connecting end being connected to the main body, and at least part of the free ends being configured to clamp the first component.

According to the fastener in the first aspect described above, the at least part of the free ends of the at least two clamping arms for clamping the first component are arranged in a spiral configuration.

According to a second aspect of the present disclosure, the present disclosure provides a fastener assembly, which comprises a fastener described above, a first component and a second component. The first component comprises a base and a post which are connected to each other. The second component is provided with a connecting hole, and can be sheathed on the post extending through the connecting hole. The fastener and the base are located at opposite sides of the second component, the at least two clamping arms clamp the post, and the at least two abutting arms abut against the second component, such that the first component is connected to the second component.

According to the fastener assembly in the second aspect described above, the post is provided with a thread, and at least part of the free ends of the at least two clamping arms is configured to engage with the thread.

The first component and the second component of the fastener assembly of the present application can be connected to each other stably via the fastener. Specifically, the fastener of the present disclosure comprises abutting arms. The abutting arms can press the base of the first component against the second component to hinder a relative movement between the first component and the second component in a horizontal direction (e.g., in a radial direction of the main body), thereby preventing the clamping arms from breaking.

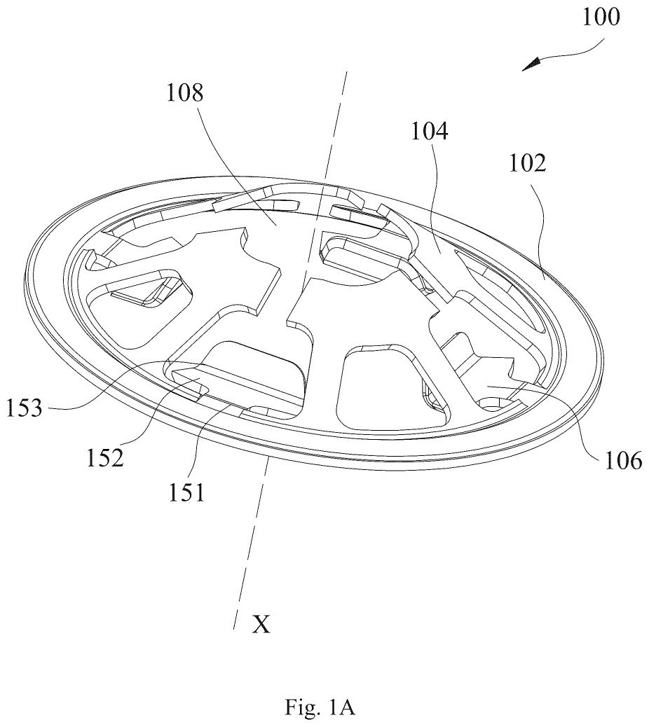

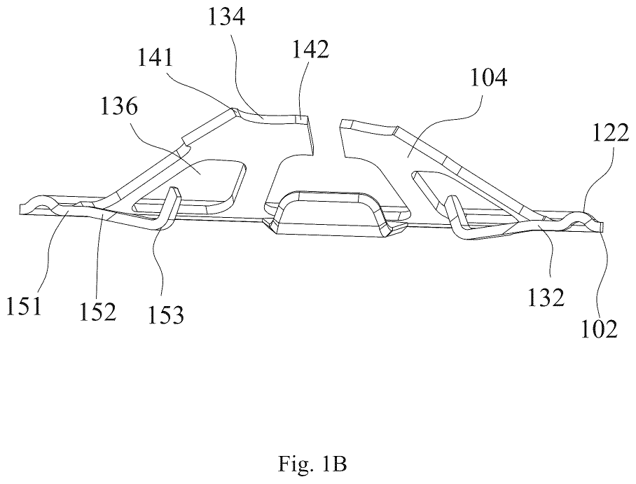

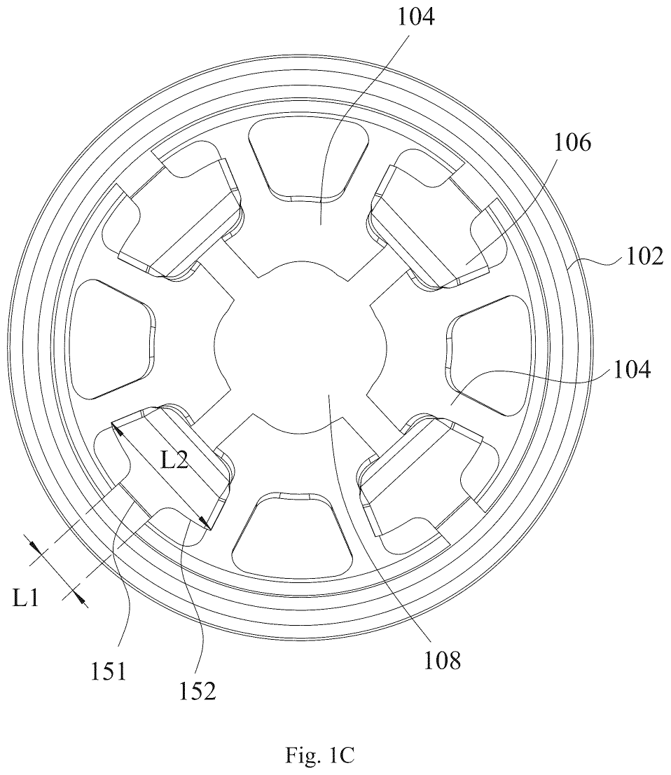

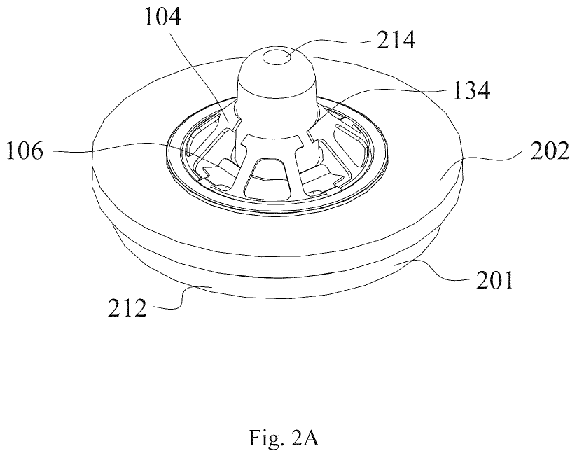

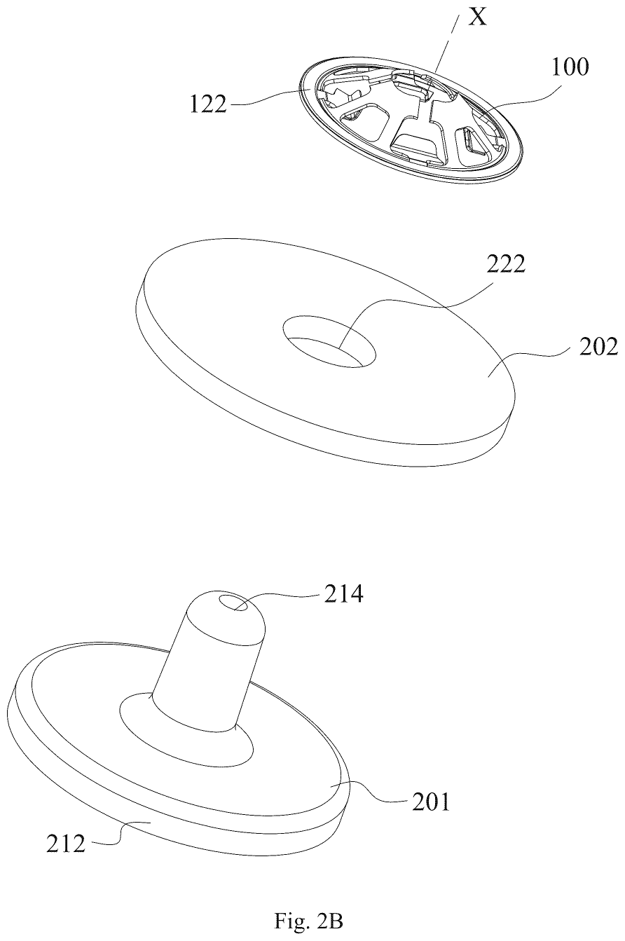

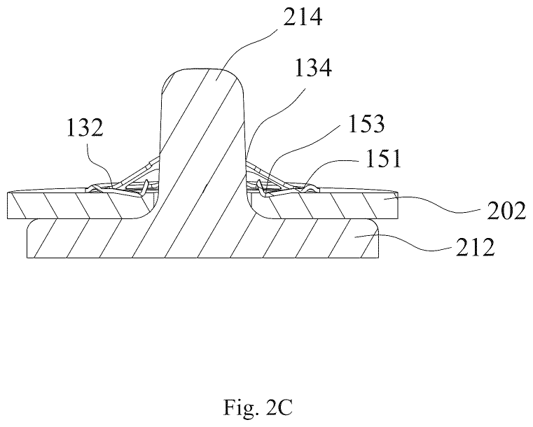

FIG. 1A is a perspective view of a fastener 100, FIG. 1B is a vertical cross-sectional view of the fastener 100 shown in FIG. 1A, and FIG. 1C is a bottom view of the fastener 100 shown in FIG. 1A. As shown in FIGS. 1A-1C, the fastener 100 comprises a main body 102, four clamping arms 104, and four abutting arms 106. The main body 102 is annular. The four clamping arms 104 and the four abutting arms 106 are respectively formed by extending from the main body 102. The four clamping arms 104 are configured to clamp a first component 201 (see FIG. 2A). The four abutting arms 106 are configured to abut against a second component 202 (see FIG. 2A).

As shown in FIGS. 1A-1C, the main body 102 is substantially a circular ring. The main body has a central axis X. In a radial direction of the main body 102, the inner part of the main body 102 is protruded upwardly to form an operating portion 122. When connecting the first component 201 to the second component 202 via the fastener 100, an operator may press the operating portion 122, to cause the fastener 100 to move toward the second component 202.

As shown in FIGS. 1A-1C, the four clamping arms 104 are uniformly arranged in a circumferential direction of the main body 102. Each clamping arm 104 is formed by extending inwardly, obliquely and upwardly from an inner periphery of the main body 102. Each clamping arm 104 has a connecting end 132 and a free end 134 which are arranged opposite to each other. The connecting end 132 is connected to the main body 102. A receiving cavity 108 is defined by the four free ends 134 and configured for receiving the first component 201 (see FIG. 2A).

As shown in FIG. 1B, in an embodiment of the present disclosure, the free end 134 comprises a first clamping surface 141 and a second clamping surface 142. In the circumferential direction of the main body 102, the first clamping surface 141 and the second clamping surface 142 are located at two opposite ends of the free end 134. A distance from the first clamping surface 141 and the second clamping surface 142 to the central axis X is slightly less than the radius of the second component 202. The first clamping surfaces 141 and the second clamping surfaces 142 of the four clamping arms 104 are arranged in a spiral configuration, such that when the first clamping surfaces 141 and the second clamping surfaces 142 clamp the first component 201, the four clamping arms 104 can clamp a post 214 of the first component 201 at different heights. When the four clamping arms 104 clamp the first component 201, the clamping arms 104 clamp the first component 201 in a first direction. As an embodiment, the first direction is a radial direction of the main body 102.

In addition, as shown in FIG. 1B, the cross-sections of the four clamping arms 104 are substantially in a bowl shape. Each clamping arm 104 is further provided with a through hole 136. The through hole 136 can improve the deformation capability of the clamping arm 104, so that the fastener 100 can be adapted to first components 201 of different sizes.

It should be noted that, although the first clamping surfaces 141 and the second clamping surfaces 142 of the free ends 134 are configured for clamping the first component 201 in the embodiment of the present disclosure, only at least part of the free ends 134 may be used for clamping the first component 201 in other embodiments. It should be further noted that, although the first clamping surface 141 and the second clamping surface 142 are located at two opposite ends of each of the free ends 134 in the circumferential direction of the main body 102 in the embodiment of the present disclosure, at least part of the free end 134 for clamping the first component 201 may be located at any positions on the free ends 134.

As shown in FIGS. 1A-1C, the four abutting arms 106 are uniformly arranged in the circumferential direction of the main body 102 and are arranged between two adjacent clamping arms 104. In other words, the four clamping arms 104 and the four abutting arms 106 are arranged at intervals in the circumferential direction of the main body 102. The abutting arms 106 are located below the clamping arms 104. Specifically, each of the abutting arms 106 is formed by extending inwardly and downwardly for a certain distance from the inner periphery of the main body 102, and then extending upwardly. When the fastener 100 connects the first component 201 to the second component 202 in place, the second component 202 is located below the fastener 100. Therefore, in other words, each of the abutting arms 106 is formed by extending inwardly from the inner periphery of the main body 102 and toward the second component 202 for a certain distance, and then extending away from the second component 202.

Specifically, each of the abutting arms 106 comprises a root portion 151, an extension portion 152 and a bent portion 153. The extension portion 152 is arranged between the root portion 151 and the bent portion 153, and is connected to the root portion 151 and the bent portion 153. The root portion 151 is configured for connection with the inner periphery of the main body 102. In the circumferential direction of the main body 102, the maximum circumferential length L1 of the extension portion 152 is greater than the maximum circumferential length L2 of the root portion 151, such that the abutting arm 106 has a large deformation capacity, and when the abutting arm 106 abuts against the second component 202, the abutting arm 106 can apply a large abutting force to the second component 202. A bottom surface of the bent portion 153 is lower than a bottom surface of the main body 102, and is configured for abutting against the second component 202. In other words, the bottom surface of the bent portion 153 is closer to an upper surface of the second component 202 than the bottom surface of the main body 102. When the bent portion 153 abuts against the second component 202, the bent portion 153 abuts against the second component 202 in a second direction. As an embodiment, the second direction is the direction of the central axis X. The second direction is substantially perpendicular to the first direction.

In addition, as shown in FIG. 1C, in the circumferential direction of the same main body 102, the circumferential length of the abutting arm 106 is greater than a gap length between two adjacent clamping arms 104, so that the abutting arm 106 is prevented from moving to above the clamping arm 104 through a gap between the two adjacent clamping arms 104 under the action of an external force.

FIG. 2A is a perspective view of a first embodiment of a fully assembled fastener assembly of the present disclosure, FIG. 2B is an exploded view of the fastener assembly shown in FIG. 2A, and FIG. 2C is a cross-sectional view of the fastener assembly shown in FIG. 2A. As shown in FIGS. 2A-2C, the first component 201 comprises a base 212 and a post 214. The base 212 is substantially plate-shaped, and the post 214 is arranged above the base 212 and is connected to the base 212. The second component 202 is substantially plate-shaped. The second component 202 is provided with a through hole 222. As an embodiment, the first component 201 and the fastener 100 are made of metal. The second component 202 is made of plastic.

As shown in FIGS. 2A-2C, when connecting the first component 201 to the second component 202 via the fastener 100, the operator first sheaths the second component 202 on the post 214 of the first component 201. Subsequently, the operator sheaths the fastener 100 on the post 214 of the first component 201. When sheathing the fastener 100 on the post, the operator may align the central axis X of the main body 102 with the central axis of the post 214, and then press the operating portion 122 of the fastener 100 to allow the post 214 to enter the receiving cavity 108. The post 214 comes into contact with the first clamping surfaces 141 and the second clamping surfaces 142 of the free ends 134 of the fastener 100, and causes the free ends 134 to move away from each other to enlarge the receiving cavity 108 until the receiving cavity 108 can receive the post 214. In other words, the clamping arms 104 are deflected around the connecting ends 132 in the process of the post 214 abutting against the first clamping surfaces 141 and the second clamping surfaces 142 and causing the free ends 134 to move away from each other. The deflection of the clamping arms 104 around the connecting ends 132 enables the first clamping surfaces 141 and the second clamping surfaces 142 of the free ends 134 to continuously apply clamping force to the post 214. After the post 214 passes through the receiving cavity 108, the operator continues to press the operating portion 122 until the bent portion 153 of the fastener 100 comes into contact with the upper surface of the second component 202. The upper surface of the second component 202 abuts against the bottom surfaces of the bent portions 153, to deflect the abutting arms 106 around the root portions 151. The deflection of the abutting arms 106 around the root portions 151 enables the bottom surfaces of the bent portions 153 to constantly apply abutting force to the upper surface of the second component 202, thereby pressing the first component 201 and the second component 202 together. After the bottom surfaces of the bent portions 153 abut against the upper surface of the second component 202, the operator continues to press the operating portion 122 until the bottom surface of the main body 102 comes into contact with the upper surface of the second component 202. In this way, the fastener 100 connects the first component 201 to the second component 202.

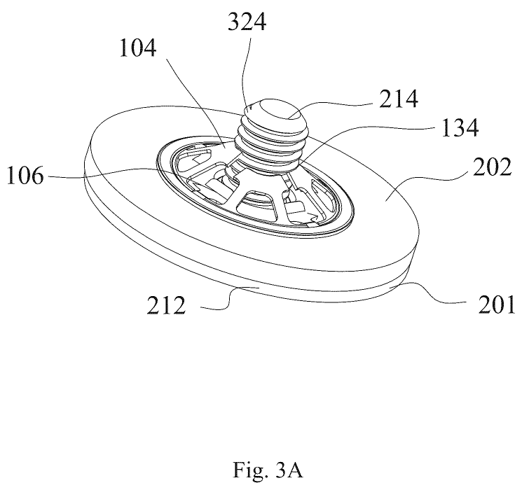

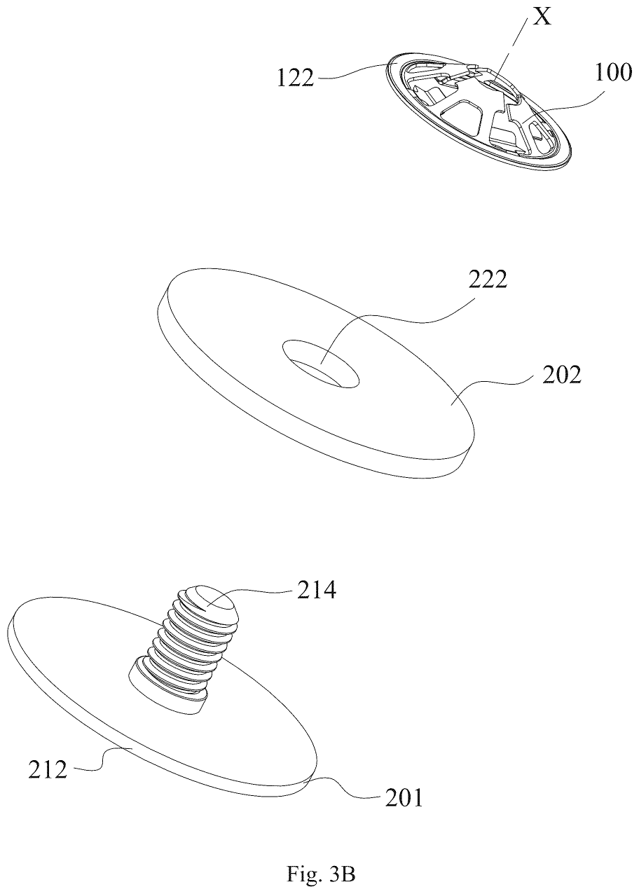

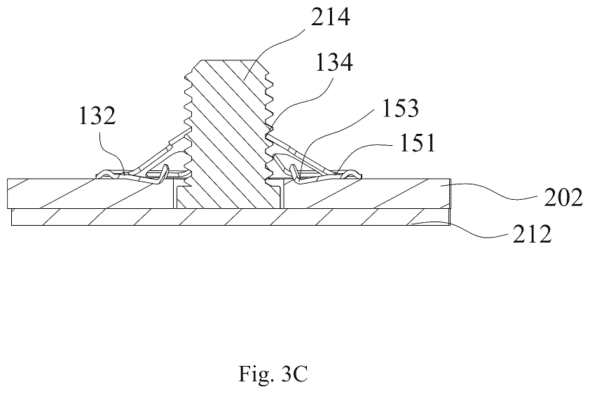

FIG. 3A is a perspective view of a second embodiment of the fully assembled fastener assembly of the present disclosure, FIG. 3B is an exploded view of the fastener assembly as shown in FIG. 3A, and FIG. 3C is a cross-sectional view of the fastener assembly as shown in FIG. 3A. The similarities between the fastener assembly shown in FIGS. 3A-3C and the fastener assembly shown in FIGS. 2A-2C will not be described in detail herein, and the differences between the fastener assembly shown in FIGS. 3A-3C and the fastener assembly shown in FIGS. 2A-2C mainly lie in that the post 214 of the fastener assembly shown in FIGS. 3A-3C is provided with a thread 324, and part of the free ends 134 of the fastener 100 for clamping the first component 201 are arranged in a spiral configuration. Such a spiral configuration can be fit with the thread 324. In an embodiment, the thread 324 is an M6 thread, and part of the free ends 134 has a spiral configuration to fit with the M6 thread.

When connecting the first component 201 to the second component 202 via the fastener 100, the operator may operate according to the process as described in the first embodiment of FIGS. 2A-2C. When the fastener 100 connects the first component 201 to the second component 202, the free ends 134 can extend into a space between two turns of the thread 324, and at least part of the free ends 134 can abut against the thread 324.

It should be noted that, although the fastener 100 of the present disclosure comprises the four clamping arms 104 and the four abutting arms 106, at least two clamping arms 104 and at least two abutting arms 106 both fall within the scope of protection of the present disclosure.

In the prior art, a fastener clamps a post of a first component by means of clamping arms, so as to connect the first component to a second component. However, the clamping arms in the prior art are prone to breakage. The inventors of the present disclosure have found that the fastening status of the first component and the second component is maintained by the clamping arms, and thus a displacement is likely to occur between the first component and the second component. In other words, the second component is likely to make relative movement in the horizontal direction (e.g., in the radial direction of the main body 102) relative to the first component, so that the clamping arms are broken due to an excessive force (e.g., a radial force in the radial direction of the main body 102).

The first component 201 and the second component 202 of the fastener assembly of the present disclosure can be connected to each other stably via the fastener 100. Specifically, the fastener 100 of the present disclosure comprises abutting arms 106. The abutting arms can tightly press the base 212 of the first component 201 and the second component 202 to hinder a relative movement between the first component 201 and the second component 202 in the horizontal direction (e.g., in the radial direction of the main body 102), thereby preventing the clamping arms 104 from breaking.

Although the present disclosure is described with reference to the examples of embodiments outlined above, various alternatives, modifications, variations, improvements and/or substantial equivalents, which are known or anticipated at present or to be anticipated before long, may be obvious to those of at least ordinary skill in the art. In addition, the technical effects and/or technical problems described in this specification are exemplary rather than limiting; Therefore, the disclosure in this specification may be used to solve other technical problems and have other technical effects and/or may solve other technical problems. Accordingly, the examples of the embodiments of the present disclosure as set forth above are intended to be illustrative rather than limiting. Various changes may be made without departing from the spirit or scope of the present disclosure. Therefore, the present disclosure is intended to embrace all known or earlier disclosed alternatives, modifications, variations, improvements and/or substantial equivalents.

What is claimed is:

1. A fastener for connecting a first component to a second component, comprising:
a main body being annular;
at least two clamping arms being formed by extending from the main body and configured to clamp the first component; and
at least two abutting arms being formed by extending from the main body and configured to abut against the second component.

2. The fastener according to claim 1, wherein
the at least two clamping arms are configured to clamp the first component in a first direction, and the at least two abutting arms are configured to abut against the second component in a second direction; and
wherein the first direction is substantially perpendicular to the second direction.

3. The fastener according to claim 1, wherein
each of the at least two abutting arms is formed by extending inwardly from the main body and toward the second component for a certain distance, and then extending away from the second component.

4. The fastener according to claim 1, wherein
each of the at least two abutting arms comprises a bent portion, and a bottom surface of the bent portion is lower than a bottom surface of the main body.

5. The fastener according to claim 4, wherein
each of the at least two abutting arms is arranged between two adjacent clamping arms and located between the at least two clamping arms and the second component.

6. The fastener according to claim 1, wherein
the at least two clamping arms are arranged at a distance from the at least two abutting arms.

7. The fastener according to claim 1, wherein
each of the at least two clamping arms has a connecting end and a free end, the connecting end being connected to the main body, and at least part of the free ends being configured to clamp the first component.

8. The fastener according to claim 7, wherein
the at least part of the free ends of the at least two clamping arms for clamping the first component are arranged in a spiral configuration.

9. A fastener assembly, comprising:
a fastener of claim 1;
a first component comprising a base and a post which are connected to each other; and
a second component being provided with a connecting hole and being capable of being sheathed on the post extending through the connecting hole,
wherein the fastener and the base are located at opposite sides of the second component, the at least two clamping arms clamp the post, and the at least two abutting arms abut against the second component, such that the first component is connected to the second component.

10. The fastener assembly according to claim 9, wherein
the post is provided with a thread, and at least part of the free ends of the at least two clamping arms are capable of fitting with the thread.
